(19) United States
(12) Patent Application Publication
(10) Pub. No.: US 2016/0129533 A1
(43) Pub. Date: May 12, 2016

(54) HYBRID BRAZE TAPES AND HYBRID BRAZE TAPE METHODS

(71) Applicant: General Electric Company, Schnectady, NY (US)

(72) Inventors: Yan Cui, Greer, SC (US); Srikanth Chandrudu Kottilingam, Simpsonville, SC (US); Brian Lee Tollison, Honea Path, SC (US); Dechao Lin, Greer, SC (US); David Edward Schick, Greenville, SC (US)

(21) Appl. No.: 14/535,721

(22) Filed: Nov. 7, 2014

(51) Int. Cl. B23K 35/36; B32B 27/32; C22C 19/05; B32B 15/08

(52) U.S. Cl. CPC B23K 35/3613; B32B 15/08; B32B 27/322; C22C 19/05

(57) ABSTRACT

A hybrid braze tapes includes a braze tape layer comprising a braze alloy composition and a binder, and, a polytetrafluoroethylene (“PTFE”) tape layer disposed adjacent a surface of the braze tape layer.

### BACKGROUND OF THE INVENTION

The subject matter disclosed herein relates to braze tapes and methods and, more specifically, to hybrid braze tapes and methods combining braze tapes with polytetrafluoroethylene (“PTFE”) tapes.

A wide variety of industry components may undergo a braze operation to add new material, modify existing material, modify the shape of a component, join multiple components together, or otherwise alter the original component. The braze operation may general comprise heating a braze alloy composition above its melting temperature (i.e., above its liquidus temperature) while disposed on a base substrate (i.e., the original component) and subsequently cool the materials to join the braze alloy and the base substrate together.

Various turbine components may, for example, undergo one or more braze cycles during original manufacture or modification pre or post utilization in a turbine. Some particular turbine components may also possess very high strength, toughness and/or other physical properties to facilitate sustained operation. Turbine components such as buckets (blades), nozzles (vanes), and other hot gas path components and combustions components of industrial and aircraft gas turbine engines may be formed of nickel, cobalt or iron-base superalloys with suitable mechanical and environmental properties.

In even some instances, because the efficiency of a turbomachine can be at least partially dependent on its operating temperatures, there may be a demand for components such as turbine buckets and nozzles to be capable of withstanding increasingly higher temperatures. Likewise, components in the fuel systems may require increasingly intricate designs to facilitate the mixing of air and/or fuel.

Components, including turbine components, that have undergone a braze cycle may thereby be reshaped, joined or otherwise modified into a suitable configuration. Braze tapes may be one option of delivering the braze alloy composition to the component. However, braze tapes may be relatively brittle and not be susceptible to working in tight gaps.

Accordingly, alternative hybrid braze tapes and methods would be welcome in the art.

### BRIEF DESCRIPTION OF THE INVENTION

In one embodiment, a hybrid braze tape is disclosed. The hybrid braze tape includes a braze tape layer comprising a braze alloy composition and a binder, and, a polytetrafluoroethylene (“PTFE”) tape layer disposed adjacent a surface of the braze tape layer.

In another embodiment, a hybrid braze tape method is disclosed. The hybrid braze tape method includes providing a base component comprising a surface and disposing a hybrid braze tape on the surface of the base component. The hybrid braze tape includes a braze tape layer comprising a braze alloy composition and a binder, and, a polytetrafluoroethylene (“PTFE”) tape layer disposed adjacent a surface of the braze tape layer. The hybrid braze tape method further includes applying heat to burn away the PTFE tape layer and to melt the braze tape layer so that it at least partially bonds with the base component.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a cross sectional schematic illustration of a hybrid braze tape according to one or more embodiments shown or described herein;

FIG. 2 is a cross sectional schematic illustration of a hybrid braze tape with an adhesive material according to one or more embodiments shown or described herein;

FIG. 3 is a cross sectional schematic illustration of a hybrid braze tape layer with an additional braze tape layer according to one or more embodiments shown or described herein;

FIG. 4 is a cross sectional schematic illustration of a hybrid braze tape with an additional polytetrafluoroethylene (“PTFE”) tape layer according to one or more embodiments shown or described herein;

FIG. 5 is an illustration of an exemplary hybrid braze tape method according to one or more embodiments shown or described herein;

FIG. 6 is an illustration of a hybrid braze tape disposed on a base component according to one or more embodiments shown or described herein;

FIG. 7 is an illustration of the hybrid braze tape disposed on the base component of FIG. 6 further disposed adjacent an additional component according to one or more embodiments shown or described herein;

FIG. 8 is an illustration of the joined based component and additional component of FIG. 6 according to one or more embodiments shown or described herein; and

FIG. 9 is an illustration of another base component and additional component about to be joined using a hybrid braze tape according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

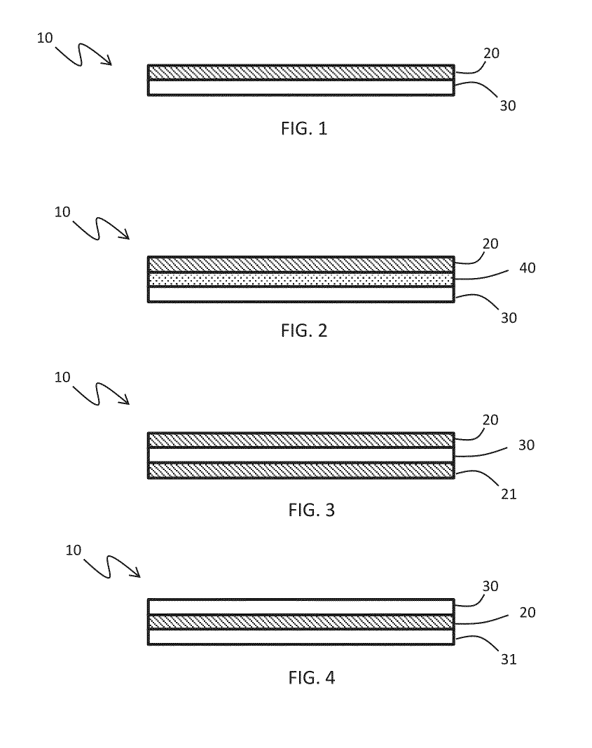

Referring now to FIGS. 1-4, various embodiments of hybrid braze tape 10 are illustrated. The hybrid braze tape 10 generally comprises a braze tape layer 20 and a polytetrafluoroethylene (“PTFE”) tape layer 30 disposed adjacent a surface of the braze tape layer 20.

The braze tape layer 20 of the hybrid braze tape 10 generally comprises a braze alloy composition and a binder. The braze alloy composition may comprise any braze material or combinations of braze materials that combine to have a melting temperature such that a sufficient application of heat can melt the braze alloy composition so that it at least partially bonds with the adjacent component. In some embodiments, the melting temperature of the braze alloy composition may be sufficiently high enough such that any suitable heat application during the brazing process can also fully burn away the PTFE tape layer 30.

In some embodiments, the braze alloy composition may comprise one or more nickel-, cobalt-, or iron-based alloys. For example, the braze alloy composition may be the same or similar to the compositions of commercially available Amdry B-93 braze material, Amdry 788 braze material, or Amdry 805 braze material respectively. In some embodiments, the braze alloy composition may comprise about 70.9 percent nickel, about 19 percent chromium and about 10.1 percent silicon such as in commercially available BNi-5 braze tape. In some particular embodiments, the braze alloy composition and the component may comprise the same material (i.e., they share the same material composition).

The binder of the braze tape layer 20 can comprise any suitable binder commercially available for application in braze tapes. For example, in some embodiments, the binder may comprise fibrillated PTFE. In some embodiments, the binder may comprise any other suitable binder to keep the braze alloy composition together in tape form and potentially provide some flexibility.

The polytetrafluoroethylene (“PTFE”) tape layer 30 of the hybrid braze tape 10 generally comprises any polytetrafluoroethylene tape such as those used for pipe fitting applications. For example, in some embodiments, the PTFE tape layer 30 may comprise what is sometimes commercially referred to as Teflon tape or plumber's tape.

The PTFE tape layer 30 can help provide flexibility to the hybrid braze tape 10 by helping to hold the braze tape layer 20 together while the overall hybrid braze tape 10 is manipulated (such as when it is applied one or more components—e.g., wrapped around a threaded pipe). Moreover, as the PTFE tape layer 30 burns away in subsequent brazing processes, the fluorine released therefrom can even help facilitate the cleaning of the surface of the component such as by helping to remove contaminants.

Referring now to FIG. 2, in some embodiments, the hybrid braze tape 10 may further comprise an adhesive material 40 disposed between and configured to hold together the braze tape layer 20 and the PTFE tape layer 30. The adhesive material 40 may comprise any suitable adhesive in any suitable medium. For example, in some embodiments, the adhesive material may comprise glue. In such embodiments, the glue may be predisposed on one or both sides of the braze tape layer 20 and/or the PTFE tape layer 30. In some embodiments, the adhesive may comprise tape, such as double sided adhesive tape.

With reference to FIGS. 1-4, the hybrid braze tape 10 may comprise a variety of different configurations of one or more braze tape layers 20 and one or more PTFE tape layers 30. For example, as illustrated in FIGS. 1 and 2, in some embodiments, the hybrid braze tape 10 may comprise a single braze tape layer 20 disposed adjacent a single PTFE tape layer 30.

However, in some embodiments, the hybrid braze tape 10 may comprise one or more additional braze tape layers 21 and or one or more additional PTFE tape layers 31 (with or without additional adhesive material 40 disposed there between). For example, as illustrated in FIG. 3, in some embodiments the hybrid braze tape 10 may comprise an additional braze tape layer 21 disposed adjacent an opposite surface of the PTFE tape layer 30 as the first braze tape layer 20. In such embodiments, the PTFE tape layer 30 may thereby be “sandwiched” by the two braze tape layers 20 and 21. Such embodiments may facilitate the deposition of even more braze material through the application of the hybrid braze tape 10. Likewise, as illustrated in FIG. 4, in some embodiments the hybrid braze tape 10 may comprise an additional PTFE tape layer 31 disposed adjacent an opposite surface of the braze tape layer 20 as the first PTFE tape layer 30. In such embodiments, the braze tape layer 20 may thereby be “sandwiched” by the two PTFE tape layers 30 and 31. Such embodiments may facilitate even more flexibility in the application of the hybrid braze tape 10.

Depending on the application of the hybrid braze tape (e.g., gap size, shape, etc.), one or more dimensions may be controlled. For example, in some embodiments, the braze tape layer 20 and the PTFE tape layer 30 of the hybrid braze tape 10 may comprise for a total thickness of greater than or equal to about 0.003 inches. Conversely, in some embodiments, the braze tape layer 20 and the PTFE tape layer 30 of the hybrid braze tape 10 may comprise for a total thickness of less than or equal to about 0.08 inches.

In even some embodiments, one either the braze tape layer 20 or the PTFE tape layer 30 may be oversized with respect to the other to ensure sufficient coverage as desired. For example, in some embodiments, the surface area of the PTFE tape layer 30 may be greater than the surface area of the braze tape layer 20 to ensure all of the braze tape layer 20 can be supported by the PTFE tape layer 30. Conversely, in some embodiments, the surface area of the braze tape layer 20 may be greater than the surface area of the PTFE tape layer 30 when relatively less PTFE material is required to provide sufficient flexibility for the braze tape layer 20.

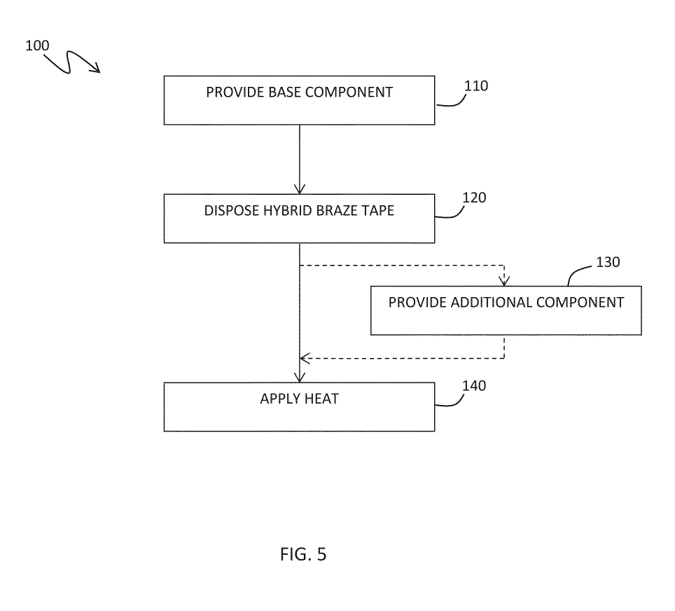

Referring now additionally to FIGS. 5-9, a hybrid braze tape method 100 is illustrated (FIG. 5) for exemplarily utilizing the disclosed hybrid braze tape 10 to braze a base component 50, either on its own, or potentially with an additional component 55.

The hybrid braze tape method 100 first comprises providing a base component 50 in step 110. The base component 50 can comprise any metal or alloy substrate suitable for a braze application. For example, the present disclosure is generally applicable to any metal or alloy component that may be brazed, particularly those components that operate within environments characterized by relatively high stresses and/or temperatures. Notable examples of such components include turbine components such as turbine buckets (blades), nozzles (vanes), shrouds, and other hot gas path and combustion components of a turbine, such as an industrial gas or steam turbine or an aircraft gas turbine engine.

For example, in some embodiments, the base component 50 may comprise a stainless steel such as 304 stainless steel. In some embodiments, the base component 50 may comprise nickel-, cobalt-, or iron-based superalloys. For example, the base component may comprise nickel-based superalloys such as Rene N4, Rene N5, Rene 108, GTD-111®, GTD-222®, GTD-444®, IN-738 and MarM 247 or cobalt-based superalloys such as FSX-414. The base component 50 may be formed as an equiaxed, directionally solidified (DS), or single crystal (SX) casting to withstand relatively higher temperatures and stresses such as may be present within a gas or steam turbine.

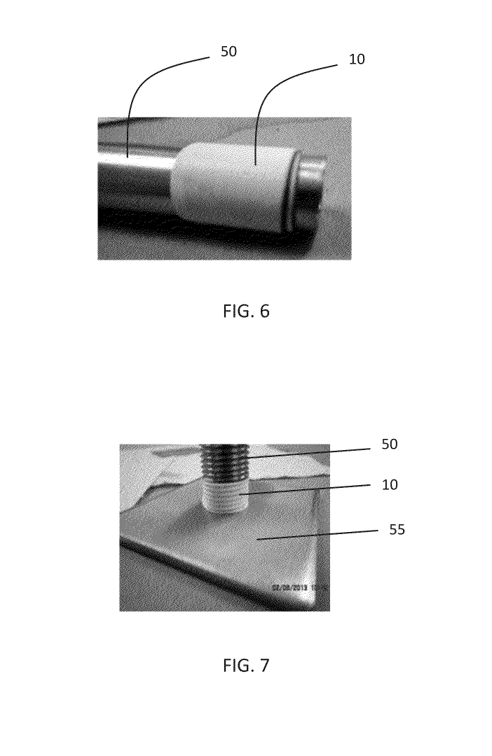

In some embodiments, the base component 50 may comprise a tube, such as a tube which is to be joined via braze to a plate (as exemplarily illustrated in FIGS. 6-8). In other embodiments, the base component 50 may have a void that is to be substantially filled via brazing a coupon thereto (as exemplarily illustrated in FIG. 9). While specific examples of base components 50 have been discussed herein, it should be appreciated that these are non-limiting and exemplary only; additional or alternative base components 50 may also be utilized in the hybrid braze tape method 100.

Still referring additionally to FIGS. 5-9, the hybrid braze tape method 100 further comprises disposing the hybrid braze tape 10 on the surface of the base component 50 in step 120. The hybrid braze tape 10 may be disposed on the surface of the base component 50 in any suitable method. For example, if the base component 50 comprises a pipe (such as illustrated in FIGS. 6-8), the hybrid braze tape 10 may be wrapped around the base component 50. If the base component 50 comprises a void for which a coupon or other type of component is to be bonded thereto, the hybrid braze tape 10 may simply be pushed, pressed, unrolled onto or simply otherwise disposed against the surface of the base component 50. Furthermore, the hybrid braze tape 10 may be secured in place using any suitable material such as braze paste or the like.

Moreover, it should be appreciated that the base component 50 may undergo any suitable preparation prior to the deposition of the hybrid braze tape 10. For example, the base component 50 may be grinded, blasted, cleaned, treated or otherwise modified prior to the placement of the hybrid braze tape 10. Moreover, the hybrid braze tape 10 may be disposed in any orientation relative the base component 50 suitable for the particular application. For example, either the braze tape layer 20 of the PTFE tape layer 30 may be the layer disposed directly onto the surface of the base component 50. Furthermore, in some embodiments, multiple pieces of hybrid braze tape 10 may be utilized at one or more different locations relative the base component 50.

In some embodiments, the hybrid braze tape 10 may be used to braze two pieces of material together (such as a pipe to a plate as illustrated in FIGS. 6-8, or a coupon to a substrate as illustrated in FIG. 9). In such embodiments, the hybrid braze tape method 100 may further comprise providing an additional component 55 adjacent the base component 50 in step 130.

For example, in embodiments where the base component 50 comprises a pipe, the additional component 55 can comprise a plate such as illustrated in FIGS. 6-8. In embodiments where the base component 50 comprises a substrate with a void, the additional component 55 may comprise a coupon to be disposed within the void. The additional component 55 may otherwise comprise any other type of component to be brazed to the base component 50. In some embodiments, the base component 50 and the additional component 55 may comprise the same material.

Still referring additionally to FIGS. 5-9, the hybrid braze tape method 100 finally comprises applying heat in step 140. Applying heat in step 140 can both burn away the PTFE tape layer 30 in addition to melting the braze tape layer 20 so that it at least partially bonds with the base component 50 (and potentially the additional component 55 when present).

The temperature, heat source(s), iterations, ramp rate, hold time, cycle and any other relevant parameters of heat application can be adjusted so as to at least partially melt the hybrid braze tape 10. For example, in some embodiments, heat may be applied within a non-oxidizing atmosphere (e.g., vacuum or inert gas). In some embodiments, heat may be applied within a range of about 2050° F. to about 2336° F. (about 1120° C. to about 1280° C.), depending on composition, for a period of about 10 minutes to about 60 minutes.

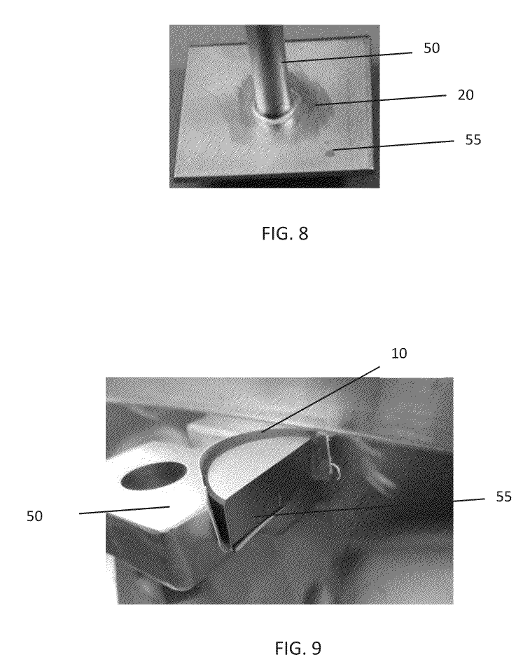

As illustrated in FIG. 8, the application of heat in step 140 of the hybrid braze tape method 100 thereby allows the braze tape layer 20 to melt and bond with the base component 50 while the PTFE tape layer 30 disappears. The PTFE tape layer 30 can thereby help provide additional flexibility to the braze tape layer 20, help ensure a tight fit in any gaps where the hybrid braze tape 10 is being applied, and/or release fluorine during the heat application that can further clean the base component 50 prior to its bonding with the braze tape layer 20.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A hybrid braze tape comprising:
a braze tape layer comprising a braze alloy composition and a binder; and,
a polytetrafluoroethylene (“PTFE”) tape layer disposed adjacent a surface of the braze tape layer.

2. The hybrid braze tape of claim 1, further comprising an adhesive material disposed between and configured to hold together the braze tape layer and the PTFE tape layer.

3. The hybrid braze tape of claim 2, wherein the adhesive material comprises double sided adhesive tape.

4. The hybrid braze tape of claim 1, wherein the braze alloy composition comprises a nickel-, cobalt-, or iron-based alloy.

5. The hybrid braze tape of claim 4, wherein the braze alloy composition comprises about 70.9 percent nickel, about 19 percent chromium and about 10.1 percent silicon.

6. The hybrid braze tape of claim 1, wherein the braze tape layer and the PTFE tape layer comprise for a total thickness of greater than or equal to about 0.003 inches.

7. The hybrid braze tape of claim 1, wherein the braze tape layer and the PTFE tape layer comprise for a total thickness of less than or equal to about 0.08 inches.

8. The hybrid braze tape of claim 1, further comprising an additional braze tape layer disposed adjacent an opposite surface of the PTFE tape layer as the first braze tape layer.

9. The hybrid braze tape of claim 1, further comprising an additional PTFE tape layer disposed adjacent an opposite surface of the braze tape layer as the first PTFE tape layer.

10. The hybrid braze tape of claim 1, wherein a surface area of the PTFE tape layer is greater than a surface area of the braze tape layer.

11. A hybrid braze tape method comprising, providing a base component comprising a surface;
disposing a hybrid braze tape on the surface of the base component, the hybrid braze tape comprising:
a braze tape layer comprising a braze alloy composition and a binder; and,
a polytetrafluoroethylene (“PTFE”) tape layer disposed adjacent a surface of the braze tape layer; and,
applying heat to burn away the PTFE tape layer and to melt the braze tape layer so that it at least partially bonds with the base component.

12. The hybrid braze tape method of claim 11 further comprising, providing an additional component adjacent the base component prior to applying heat, wherein the hybrid braze tape is disposed between the base component and the adjacent component, and wherein subsequently applying heat further causes the braze tape layer to at least partially bond with the additional component.

13. The hybrid braze tape method of claim 12, wherein the base component comprises a tube.

14. The hybrid braze tape method of claim 12, wherein the additional component comprises a plate.

15. The hybrid braze tape method of claim 12, wherein the base component and the additional component comprise the same material.

16. The hybrid braze tape method of claim 11, wherein the base component comprises a turbine component.

17. The hybrid braze tape method of claim 11, wherein the base component comprises a nickel-, cobalt-, or iron-based alloy.

18. The hybrid braze tape method of claim 17, wherein the braze alloy composition comprises a nickel-, cobalt-, or iron-based alloy.

19. The hybrid braze tape method of claim 18, wherein the braze alloy composition comprises about 70.9 percent nickel, about 19 percent chromium and about 10.1 percent silicon.

20. The hybrid braze tape method of claim 11, wherein the hybrid braze tape further comprises an adhesive material disposed between and configured to hold together the braze tape layer and the PTFE tape layer.
